(19) United States
(12) Patent Application Publication
(10) Pub. No.: US 2021/0089823 A1
(43) Pub. Date: Mar. 25, 2021

(54) INFORMATION PROCESSING DEVICE, INFORMATION PROCESSING METHOD, AND NON-TRANSITORY COMPUTER-READABLE STORAGE MEDIUM

(71) Applicant: CANON KABUSHIKI KAISHA, Tokyo (JP)

(72) Inventors: Yuichiro Iio, Tokyo (JP); Atsuyuki Suzuki, Yokohama-shi (JP)

(21) Appl. No.: 17/029,164

(22) Filed: Sep. 23, 2020

(30) Foreign Application Priority Data
Sep. 25, 2019 (JP) 2019-174542

(51) Int. Cl. G06K 9/62; G06F 16/56; G06F 16/55; G06N 3/08; G06N 3/04

(52) U.S. Cl. CPC G06K 9/6256; G06F 16/56; G06F 16/55; G06K 9/6267; G06N 3/0454; G06K 9/6215; G06N 3/08

(57) ABSTRACT

An information processing device comprises a setting unit configured to set, as difficult case data, training data for which an erroneous result is output by a hierarchical neural network that has performed training using a training data group, an updating unit configured to generate an updated hierarchical neural network in which a layer for detecting the difficult case data is added to the hierarchical neural network, and a training unit configured to perform training processing of the updated hierarchical neural network using the training data group.

### BACKGROUND OF THE INVENTION

### Field of the Invention

The present invention relates to a training technique in a hierarchical neural network.

### Description of the Related Art

There is a technique for performing training of the contents of data, such as images and sound, and performing recognition. Herein, the purposes for which recognition processing is performed are referred to as recognition tasks. There are various recognition tasks, such as a face recognition task for detecting human face regions from images, an object category recognition task for distinguishing categories (cats, cars, buildings, etc.) to which objects (photographic subjects) in images belong, and a scene type recognition task for distinguishing categories (cities, mountains, seashores, etc.) to which scenes belong, for example.

The technique of neural networks is known as a technique for performing training and execution of recognition tasks as described above. Multilayered neural networks that are “deep” (that have many layers) are referred to as deep neural networks (DNNs), and have been attracting much attention in recent years for their high performance. A DNN is formed from an input layer to which data is input, a plurality of intermediate layers, and an output layer from which a recognition result is output. In a training phase of a DNN, an estimation result output from the output layer, and teacher information are input to a preset loss function to calculate a loss (indicator indicating the difference between the estimation result and the teacher information), and training is performed using back propagation, etc., so that the loss is minimized.

A technique called multitask training is known, in which training of a plurality of tasks that are related to one another is performed simultaneously during DNN training, and the accuracy of each task is thereby improved. For example, Japanese Patent Laid-Open No. 2016-6626 discloses a technique in which training of a classification task regarding whether or not a person is present in an input image and training of a regression task regarding the position of a person in an input image are performed simultaneously, and the position of a person can thereby be accurately detected even if a part of the person is concealed.

In Japanese Patent Laid-Open No. 2019-32773, the estimation accuracy of a main task is improved by performing estimation in a plurality of sub-tasks using a DNN, and integrating the estimation results of the different sub-tasks in a later stage.

A recognition task performed by a neural network may output an erroneous estimation result. In particular, in a case such as when there is a lack of training data regarding a specific case, an erroneous estimation may be made for the specific case. Even if there is no lack of training data, estimation accuracy may be low (e.g., the precision or recall of the estimation may be low) for a specific case.

### SUMMARY OF THE INVENTION

The present invention provides a training technique for improving the accuracy with regard to a case for which accuracy is low while reducing the influence of degradation on overall accuracy in a hierarchical neural network.

According to the first aspect of the present invention, there is provided an information processing device comprising: a setting unit configured to set, as difficult case data, training data for which an erroneous result is output by a hierarchical neural network that has performed training using a training data group; an updating unit configured to generate an updated hierarchical neural network in which a layer for detecting the difficult case data is added to the hierarchical neural network; and a training unit configured to perform training processing of the updated hierarchical neural network using the training data group.

According to the second aspect of the present invention, there is provided an information processing method comprising: setting, as difficult case data, training data for which an erroneous result is output by a hierarchical neural network that has performed training using a training data group; generating an updated hierarchical neural network in which a layer for detecting the difficult case data is added to the hierarchical neural network; and performing training processing of the updated hierarchical neural network using the training data group.

According to the third aspect of the present invention, there is provided a non-transitory computer-readable storage medium storing a computer program for causing a computer to function as: a setting unit configured to set, as difficult case data, training data for which an erroneous result is output by a hierarchical neural network that has performed training using a training data group; an updating unit configured to generate an updated hierarchical neural network in which a layer for detecting the difficult case data is added to the hierarchical neural network; and a training unit configured to perform training processing of the updated hierarchical neural network using the training data group.

Further features of the present invention will become apparent from the following description of exemplary embodiments (with reference to the attached drawings).

### BRIEF DESCRIPTION OF THE DRAWINGS

FIG. 1 is a block diagram illustrating an example of a functional configuration of a neural network processing device.

FIG. 2 is a flowchart of processing performed by a neural network processing device 1000.

FIG. 3 is a flowchart illustrating details of processing in step S202.

FIG. 4 is a flowchart illustrating details of training processing in step S205.

FIG. 5 is a diagram illustrating a typical flow of training processing performed by a DNN performing a classification task.

FIG. 6A is a diagram illustrating a state in which CNN feature vectors in intermediate layer of a DNN performing a classification task are visualized on a feature space.

FIG. 6B is a diagram describing misclassification.

FIG. 7A is a diagram illustrating one example of an initial DNN model 120.

FIG. 7B is a diagram illustrating one example of the initial DNN model 120 after updating.

FIG. 8 is a flowchart illustrating details of processing in step S202.

FIG. 9A is a diagram illustrating one example of an initial DNN model 120.

FIG. 9B is a diagram illustrating one example of the initial DNN model 120 after updating.

FIG. 10 is a block diagram illustrating an example of a functional configuration of a neural network processing device 3000.

FIG. 11 is a flowchart of processing performed by the neural network processing device 3000.

FIG. 12A is a diagram describing non-detection and mis-detection.

FIG. 12B is a diagram describing non-detection and mis-detection.

FIG. 12C is a diagram describing non-detection and mis-detection.

FIG. 13 is a block diagram illustrating an example of a hardware configuration of a computer device.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate.

Furthermore, in the attached drawings, the same reference numerals are given to the same or similar configurations, and redundant description thereof is omitted.

### First Embodiment

In the present embodiment, a neural network processing device that accurately performs a classification task will be described. A classification task is a task for distinguishing which one of a plurality of predetermined classes subjects included in input images belong to. In the present embodiment, a neural network processing device will be described which performs processing of a classification task for distinguishing which one of three classes (“dog”, “cat”, and “pig”) objects included in input images belong to using a DNN (a hierarchical neural network).

Typically, a DNN that performs a classification task outputs, in response to an input image, a class likelihood vector indicating the likelihood (class likelihood) of each class being present in the input image. For example, if an image showing a cat is input to the DNN as an input image, the DNN outputs a class likelihood vector ([dog, cat, pig]=[0.10, 0.85, 0.05]) that enumerates the likelihood (0.10) of the class “dog”, the likelihood (0.85) of the class “cat”, and the likelihood (0.05) of the class “pig”. Due to the likelihood of the class “cat” being highest in this class likelihood vector, the DNN has distinguished the cat in the input image as belonging to the class “cat”.

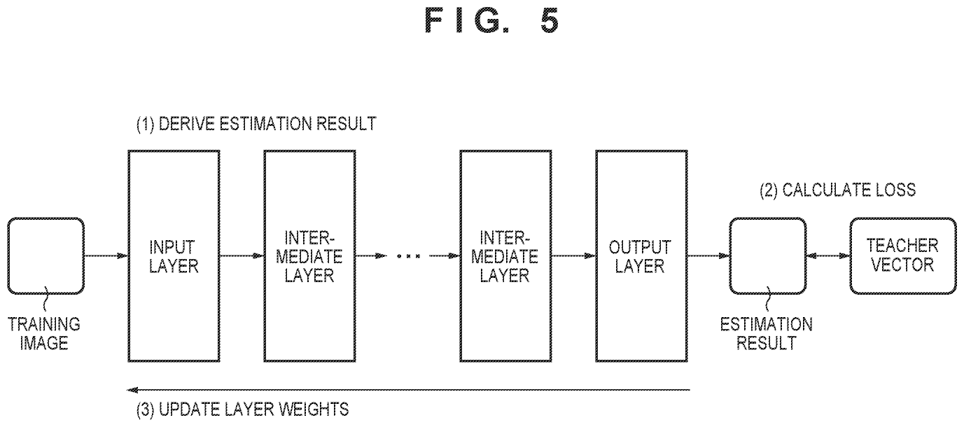

First, a typical flow of training processing performed by a DNN performing a classification task will be described with reference to FIG. 5. A plurality of pieces of training data are used in the training by a DNN performing a classification task. Training data is composed of a pair of a training image and a correct class label. A training image is an image including an object the training of which by the DNN is desired, and a correct class label is a character sequence indicating a class to which the object belongs.

First, as illustrated as (1), a training image is input to an input layer of the DNN, a class likelihood vector as an estimation result of a class corresponding to an object in the training image is derived by causing intermediate and output layers to operate, and the class likelihood vector is output from the output layer. The layers of the DNN hold weighting coefficients, which are training parameters, and in each layer, processing for outputting, to the subsequent layer, results obtained by applying weight to input using weighting coefficients is performed. Consequently, a class likelihood vector corresponding to the training image is derived at the output layer. A class likelihood vector is a one-dimensional vector including likelihoods corresponding to classes as elements, and in the above-described example, is a one-dimensional vector including the likelihood of the class “dog”, the likelihood of the class “cat”, and the likelihood of the class “pig” as elements.

Next, as illustrated as (2), a function value that can be obtained by inputting the difference between the class likelihood vector and a teacher vector to a loss function is calculated as a loss. A teacher vector is a one-dimensional vector including the same number of elements as the class likelihood vector, and is a one-dimensional vector in which the element corresponding to the correct class label paired with the training image input to the input layer has the value “1”, and all other elements have the value “0”. If the correct class label paired with the training image input to the input layer is “cat”, the corresponding teacher vector would be [dog, cat, pig]=[0, 1, 0].

Finally, as illustrated as (3), the weighting coefficients of the layers in the DNN are updated based on the calculated loss using back propagation, etc. Since back propagation is a known technique, description thereof is omitted.

Typically, a DNN performing a classification task performs classification of an object in an input image by extracting feature vectors (CNN feature vector) from the input image in an intermediate layer in which a plurality of convolutional layers are connected, and integrating the feature vectors in fully-connected layers of the DNN.

Furthermore, the training processing of the DNN is accomplished by updating the weighting coefficients of the layers in the DNN by repeating the processing in (1), (2), and (3) above and thereby gradually reducing the loss.

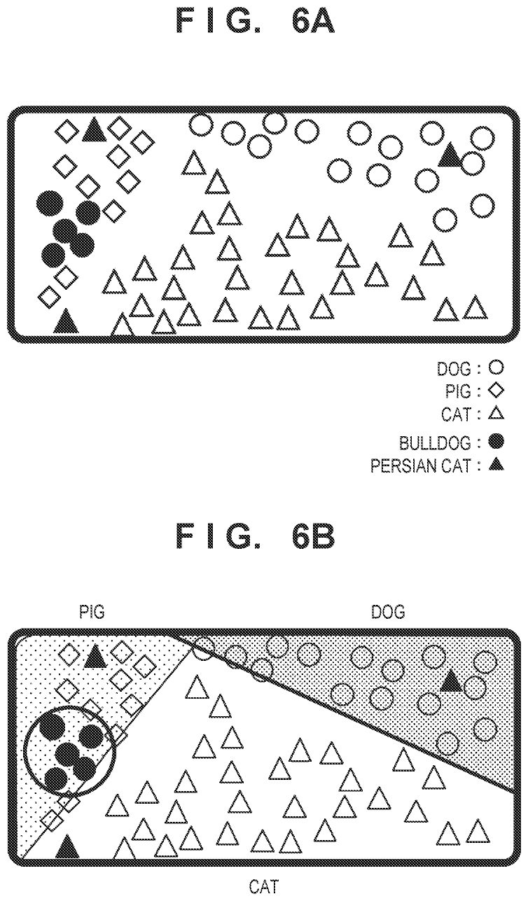

FIG. 6A illustrates a state in which CNN feature vectors in an intermediate layer of a DNN performing a classification task are visualized on a feature space. CNN feature vectors of training images for which the correct class label is “dog” are illustrated as ∘, CNN feature vectors of training images for which the correct class label is “pig” are illustrated as ⋄, and CNN feature vectors of training images for which the correct class label is “cat” are illustrated as Δ. In addition, CNN feature vectors of bulldogs, which belong to the class “dog”, are illustrated as •, and CNN feature vectors of Persian cats, which belong to the class “cat”, are illustrated as ▴. The fully-connected layers in the DNN classify an object in an input image based on these CNN feature vectors.

In a classification task, misclassification, i.e., a situation in which an object belonging to a given class is erroneously classified into a different class, occurs. Misclassification consists of misclassification a, in which an object is classified into a wrong class due to the object being unknown to the DNN (i.e., insufficient training of the object), and misclassification b, in which objects of a specific class are consistently misclassified into a specific class.

In the case of misclassification a, the fully-connected layers in the DNN cannot correctly determine which class an input image belongs to because an extracted CNN feature vector does not have sufficient performance. The distribution of the CNN feature vectors of Persian cats in FIG. 6A is one example of a state causing misclassification a. As illustrated in FIG. 6A, the CNN feature vectors of Persian cats are distributed at various positions in the feature space even though the CNN feature vectors are similarly those of Persian cats, and feature vectors indicating the characteristics of “cats” are not extracted to a sufficient extent (the DNN cannot tell the subject of the images). In order to suppress the occurrence of misclassification a characterized as such, training in the intermediate layer needs to be performed to a sufficient extent.

On the other hand, in the case of misclassification b, while CNN feature vectors are sufficiently extracted as features of images, classification into a wrong class is performed when the fully-connected layers of the DNN perform classification. The distribution of the CNN feature vectors of bulldogs in FIG. 6A is one example of a state that causes misclassification b. As illustrated in FIG. 6A, the CNN feature vectors of bulldogs are close to one another on the feature space, and it can be said that features indicating the characteristics of bulldogs are successfully extracted. However, the CNN feature vectors of bulldogs are distant from the CNN feature vectors of many other dogs on the feature space. In the example in FIG. 6A, the distribution of the CNN feature vectors of bulldogs is included in the distribution of the CNN feature vectors of pigs. In such a case, the DNN may misclassify bulldogs into the class “pig”, as illustrated in FIG. 6B. In particular, misclassification b readily occurs if there are not so many samples of bulldogs or if the fully-connected layers of the DNN are light-weighted. In the present embodiment, an improvement in the accuracy of a classification task is realized by suppressing the occurrence of misclassification b.

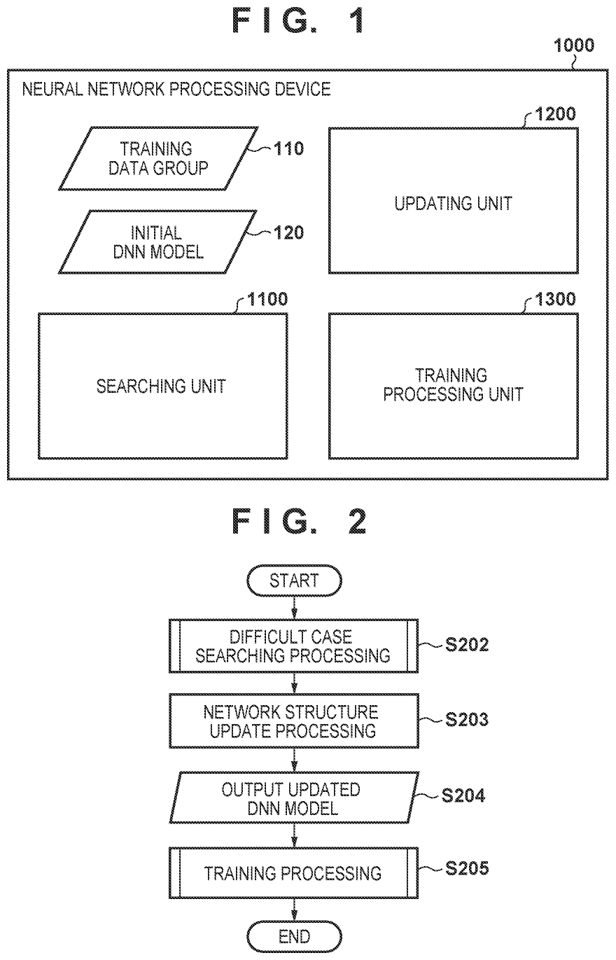

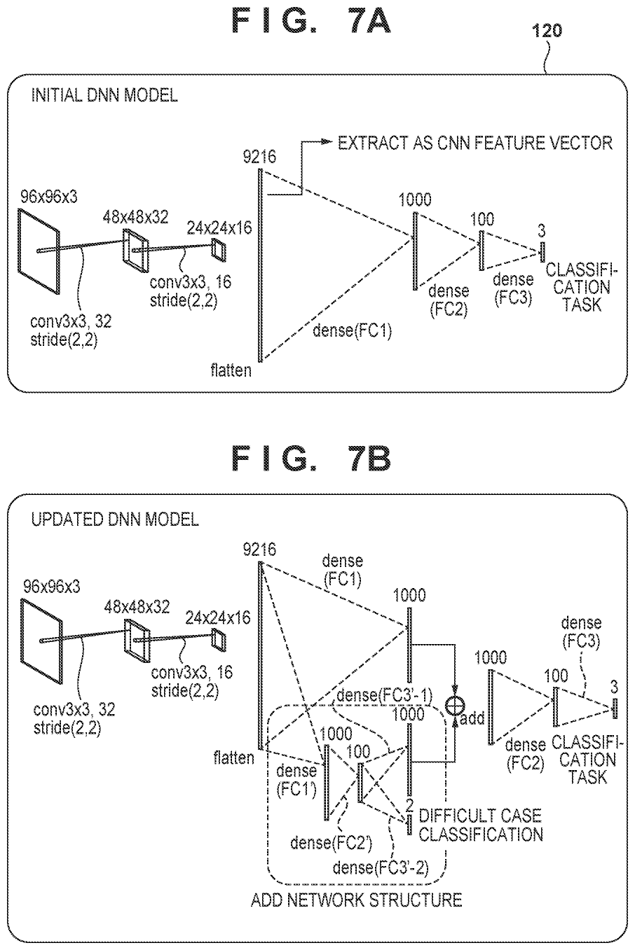

Next, an example of a functional configuration of a neural network processing device that performs a classification task using a DNN will be described with reference to the block diagram in FIG. 1. Training data group 110 is a data set including a plurality of pairs of a training image and a correct class label that is a character sequence indicating the class which an object included in the training image belongs to, and is a data set for a classification task. An initial DNN model 120 is a DNN model that has performed training using the training data group 110 in advance. One example of an initial DNN model 120 performing a classification task is illustrated in FIG. 7A. The initial DNN model 120 illustrated in FIG. 7A is a DNN model that receives a 96×96 pixel RGB image (having three planes, namely the R plane, the G plane, and the B plane) as input, and performs classification into one of three classes through two convolutional layers and three fully-connected layers. A 9216×1 sized tensor (one-dimensional vector) output from the last convolutional layer is a CNN feature vector in the initial DNN model 120. Note that the DNN structure applicable to the present embodiment is not limited to such a structure, and other structures may also be adopted. A searching unit 1100 searches for training data misclassified (misclassification b) by the initial DNN model 120. An updating unit 1200, based on the result of the search by the searching unit 1100, generates a DNN model having a new structure in which a network structure that is capable of performing a difficult case detection task for detecting a difficult case is added to the initial DNN model 120. A training processing unit 1300 performs training processing of the DNN model having the new network structure, updated by the updating unit 1200.

Note that, in the present embodiment, a neural network processing device 1000 having the configuration in FIG. 1 is formed using one device. However, the neural network processing device 1000 having the configuration in FIG. 1 may be formed using multiple devices.

Next, processing performed by the neural network processing device 1000 will be described based on the flowchart in FIG. 2.

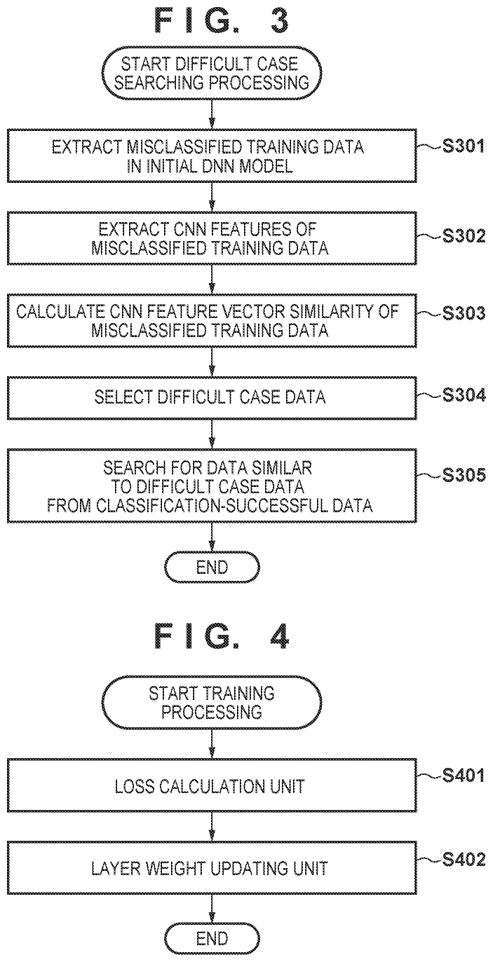

In step S202, the searching unit 1100 performs processing for setting, as difficult case data, training data that has been misclassified in the classification task by the initial DNN model 120 among training data constituting the training data group 110. The details of the processing in step S202 will be described based on the flowchart in FIG. 3.

In step S301, the searching unit 1100 extracts, from among the training data included in the training data group 110, training data that has been misclassified in the classification task by the initial DNN model 120.

For example, for each piece of training data included in the training data group 110, the searching unit 1100 acquires a class likelihood vector output from the initial DNN model 120 by inputting the training image included in the training data to the initial DNN model 120. Furthermore, for each piece of training data included in the training data group 110, the searching unit 1100 determines whether or not the class corresponding to the highest likelihood in the class likelihood vector corresponding to the training data and the class indicated by the correct class label included in the training data match. Furthermore, the searching unit 1100 extracts, from the training data group 110, training data for which the searching unit 1100 has made the determination that the classes do not match among the training data included in the training data group 110. The training data extracted by the searching unit 1100 from the training data group 110 in step S301 becomes a difficult case data candidate.

In step S302, for each piece of training data extracted as a difficult case data candidate in step S301, the searching unit 1100 acquires the output (CNN feature vector) from an intermediate layer of the initial DNN model 120 when the training image included in the training data was input. Since the initial DNN model 120 extracts CNN feature vectors from training images using an intermediate layer in which a plurality of convolutional layers are connected, the searching unit 1100 acquires the output from the intermediate layer as a CNN feature vector.

In step S303, the searching unit 1100 calculates a similarity in CNN feature vectors (CNN feature vector similarity) between training data extracted as difficult case data candidates in step S301. For example, since a CNN feature vector in the initial DNN model 120 illustrated in FIG. 7A is expressed by a 9216×1 sized one-dimensional vector, the similarity between CNN feature vectors (CNN feature vector similarity) can be calculated as a cosine similarity between the one-dimensional vectors. Note that the CNN feature vector similarity is not limited to a cosine similarity between CNN feature vectors, and may be a similarity between CNN feature vectors that is calculated using another calculation method.

In step S304, the searching unit 1100 selects, from among training data extracted as difficult case data candidates in step S301, “training data which has the same correct class label and for which the CNN feature vector similarity between one another is greater than or equal to a threshold” as difficult case data.

If training data constituting a group of training data in which the CNN feature vector similarity between one another is greater than or equal to the threshold have different correct class labels, such training data cannot be separated from one another with the current CNN feature vectors, and this is a misclassification pattern belonging to above-described misclassification a.

In the present embodiment, it is supposed that a threshold Ts applied to the CNN feature vector similarity and a threshold Tc applied to the ratio of difficult case data among difficult case data candidates are set in advance as hyperparameters. These hyperparameters may be set by a user performing a manual operation, or may be set by the neural network processing device 1000 through some processing.

In this case, the searching unit 1100 selects, from among training data extracted as difficult case data candidates in step S301, training data which has the same correct class label and for which the CNN feature vector similarity between one another is greater than or equal to the threshold Ts as difficult case data. Furthermore, if the ratio of “the number of training data selected as difficult case data” to the “number of training data extracted as difficult case data candidates” is greater than or equal to the threshold Tc, the searching unit 1100 provides the difficult case data with a “difficult-to-classify” label as additional teacher information.

For example, if Ts=0.6 and Tc=0.9, the searching unit 1100 selects, from among training data extracted as difficult case data candidates, training data which has the same correct class label and for which the CNN feature vector similarity between one another is greater than or equal to 0.6 as difficult case data. Furthermore, if the ratio of “the number of training data selected as difficult case data” to the “number of training data extracted as difficult case data candidates” is greater than or equal to 90%, the searching unit 1100 provides the difficult case data with the “difficult-to-classify” label as additional teacher information.

In a set of readily-misclassified training data, the “difficult-to-classify” label is used to distinguish a set of training data that are close to one another on the CNN feature space from other training data. Note that, if there are a plurality of sets of training data that satisfy the conditions for providing the “difficult-to-classify” label, each of the sets of training data may be provided with a corresponding “difficult-to-classify” label.

While a difficult-to-classify case has been described taking “bulldog” as an example for simplicity, a difficult-to-classify case is never formed by the user explicitly setting a grouping of a difficult-to-classify case, such as dog type, because categorization is actually performed based on only the CNN feature vector similarity.

In step S305, the searching unit 1100 searches, from among training data that are not difficult case data (classification-successful training data) in the training data group 110, for training data for which the CNN feature vector similarity between the training data and training data serving as difficult case data is greater than or equal to the threshold. If classification-successful training data for which the CNN feature vector similarity between the classification-successful training data and training data serving as difficult case data is greater than or equal to the threshold are found among the classification-successful training data as a result of this search, the searching unit 100 provides the “difficult-to-classify” label to such classification-successful training data.

Specifically, the searching unit 1100 acquires CNN feature vector of classification-successful training data corresponding to the same correct class label as the correct class label of the difficult case data from the intermediate layer of the initial DNN model 120 in a similar manner as described above. Furthermore, if the CNN feature vector similarity between the CNN feature vectors of the difficult case data and the CNN feature vectors of classification-successful training data corresponding to the same correct class label as the correct class label of the difficult case data is greater than or equal to the threshold Ts, the searching unit 1100 provides such classification-successful training data with the “difficult-to-classify” label as additional teacher information.

As a result of the above-described processing, the “difficult-to-classify” label is provided to a set of training data in the training data group 110 that have CNN feature vectors that were successfully distinguished from other CNN feature vectors but were difficult to classify. Note that here, while the extraction of difficult case data was performed using all training images belonging to the training data group 110, there is no limitation to this, and the extraction of difficult case data may be performed using only some of the training data in the training data group 110. Alternatively, difficult case data may be extracted from validation data prepared separately from training data.

Returning to FIG. 2, next, in step S203, the updating unit 1200 adds a network structure for detecting the difficult-to-classify case to an intermediate layer of the initial DNN model 120. Specifically, the updating unit 1200 adds one or more fully-connected layers that receive CNN feature vectors as input and perform a classification of whether the difficult-to-classify case or not to the initial DNN model 120, and updates the initial DNN model 120 into a structure in which the output from the added fully-connected layers is added to the input of existing fully-connected layers.

FIG. 7B illustrates one example of a structure of the initial DNN model 120 after updating (updated DNN model; updated hierarchical neural network), which is obtained by updating the initial DNN model 120 having the structure illustrated in FIG. 7A using the updating unit 1200. For convenience, the three fully-connected layers of the initial DNN model 120 are each referred to as an FC1 layer, an FC2 layer, and an FC3 layer. The FC1 layer receives a CNN feature vector, which is a one-dimensional vector having 9216 elements, as input, and outputs a feature vector that is a one-dimensional vector having 1000 elements. The FC2 layer receives the “feature vector that is a one-dimensional vector having 1000 elements” output from the FC1 layer as input, and outputs a feature vector that is a one-dimensional vector having 100 elements. The FC3 layer receives the “feature vector that is a one-dimensional vector having 100 elements” output from the FC2 layer as input, and outputs a class likelihood vector, which is a one-dimensional vector having 3 elements.

Here, an FC1′ layer, an FC2′ layer, and an FC3′-2 layer are added to the network structure of the initial DNN model 120 by the updating unit 1200. The FC1′ layer receives a CNN feature vector, which is a one-dimensional vector having 9216 elements, as input, and outputs a feature vector that is a one-dimensional vector having 1000 elements. The FC2′ layer receives the “feature vector that is a one-dimensional vector having 1000 elements” output from the FC1′ layer as input, and outputs a feature vector that is a one-dimensional vector having 100 elements. The FC3′-2 layer receives the “feature vector that is a one-dimensional vector having 100 elements” output from the FC2′ layer as input, and outputs, as an estimation result, estimated class likelihoods for a 2-class classification of whether the difficult-to-classify case or not. Furthermore, the updating unit 1200 adds an FC3′-1 layer that receives the “feature vector that is a one-dimensional vector having 100 elements” output from the FC2′ layer as input, and outputs a feature vector that is a one-dimensional vector having 1000 elements. Furthermore, the updating unit 1200 performs modification into a network structure in which the “feature vector that is a one-dimensional vector having 1000 elements” output from the FC1 layer and the “feature vector that is a one-dimensional vector having 1000 elements” output from the FC3′-1 layer are added.

Note that in a case in which N (where N is an integer of 2 or greater) patterns of difficult case data are generated in step S304 (in a case in which the number of sets of training data satisfying the conditions for providing the “difficult-to-classify” label is N), the updating unit 1200 updates the structure of the initial DNN model 120 as follows.

That is, the updating unit 1200 adds an N number of layers having 2-class classification network structures for classifying whether a difficult-to-classify case or not to the initial DNN model 120, and performs an update into a structure in which an N number of one-dimensional vectors (feature vectors) output from the N number of layers are added to the output from the FC1 layer.

As a result of the above-described processing, feature vectors relating to the difficult-to-classify case can be provided to the FC2 layer by using the FC1′ layer and the FC2′ layer and extracting feature vectors unique to the difficult-to-classify case that were lost in a connected layer of the initial DNN model 120, and adding the output from the FC3′-1 layer to existing feature vectors. Thus, the FC2 layer and the FC3 layer receive features that are important for the classification of classification-successful training data among the training data from the FC1 layer, and receive features that are important for the classification of difficult-to-classify data from the FC3′-1 layer. Accordingly, the estimation/classification accuracy with regard to difficult-to-classify data can be improved while maintaining the estimation/classification accuracy with regard to classification-successful training data in the final estimation result. Note that, while the output of the added fully-connected layers is connected to the output of the first layer (FC1) among the existing fully-connected layers in the present embodiment, there is no intention to limit the position of connection. For example, a structure may be adopted in which the output of FC2′ and the output of FC2 are connected. In addition, while a structure composed of three fully-connected layers is used here to describe the configuration of the one or more fully-connected layers that are added, any structure can be adopted.

Next, in step S204, the updating unit 1200 outputs the updated DNN model having the structure updated in step S203. In step S205, the training processing unit 1300 subjects the updated DNN model output from the updating unit 1200 in step S204 to network training processing for performing the classification task.

Note that, with regard to the weighting coefficients of the layers other than the layers newly added in the updated DNN model, weighting coefficients in the corresponding layer in the initial DNN model 120 are carried over. The details of the training processing in step S205 will be described based on the flowchart in FIG. 4.

In step S401, for each piece of training data included in the training data group 110, the training processing unit 1300 calculates a class likelihood vector output from the updated DNN model by inputting the training image included in the training data to the updated DNN model. Furthermore, for each piece of training data included in the training data group 110, the training processing unit 1300 calculates a difference between the class likelihood vector calculated for the training data and the teacher vector corresponding to the training data as a first loss. Furthermore, the training processing unit 1300 calculates, as a second loss, a loss based on the estimation result of the 2-class classification of whether the difficult-to-classify case or not and the “difficult-to-classify” label. The “loss based on the estimation result of the 2-class classification of whether the difficult-to-classify case or not and the ‘difficult-to-classify’ label” can be calculated using a desired loss function in accordance with the task, and cross entropy error is typically used in many cases.

In step S402, the training processing unit 1300 updates the weighting coefficients of target layers in the updated DNN in accordance with the first loss and the second loss (for example, by using back-propagation, etc., based on the first loss and the second loss). In the added network, the “difficult-to-classify” label is used as teacher information. The network is subjected to training such that 1 is output for data with the “difficult-to-classify” label, and 0 is output for data without the “difficult-to-classify” label (classification-successful training data). The difference between the “difficult-to-classify” label and the estimation result as to whether the difficult-to-classify case or not for input training data is used as the second loss, and the second loss is gradually reduced as weighting coefficients are updated. Accordingly, features unique to the difficult-to-classify case will be extracted by the FC1′ layer and the FC2′ layer, and will be provided to the FC2 layer. In addition, the feature of “not being the difficult-to-classify case” is extracted also for classification-successful training data, and the feature is provided to the FC2 layer. For example, upon input of training data from which the features of “pigs” illustrated in FIGS. 6A and 6B are extracted, the feature of “not being a bulldog, which is the difficult-to-classify case,” will be provided, and thus, the training data can be classified as “pigs” more accurately. In the present embodiment, the plurality of convolutional layers for extracting CNN feature vectors have performed a sufficient amount of training through the training by the initial DNN model 120, and are in a state such that the convolutional layers can extract features of classification targets, including images belonging to the difficult-to-classify case. In addition, high classification accuracy is exhibited also in the classification by the fully-connected layers, with regard to classification targets other than the difficult-to-classify case. Thus, in step S402, the updating of weighting coefficients is not performed for the intermediate layer extracting CNN feature vectors, in order to improve the accuracy with regard to the difficult-to-classify case while maintaining the accuracy with regard to existing training data for which the classification accuracy is already high. In addition, the updating of weighting coefficients is not performed also for the fully-connected layer that extracts, based on CNN feature vectors, features for correctly classifying training data not belonging to the difficult-to-classify case, that is, the fully-connected layer (the FC1 layer in FIG. 78) that is connected to the output of the added fully-connected layers. In step S402, the weighting coefficients of the added fully-connected layers (the FC1′ layer, the FC2′ layer, the FC3′-1 layer, and the FC3′-2 layer in FIG. 7B) and the weighting coefficients of the fully-connected layers following the added fully-connected layers (the FC2 layer and the FC3 layer in FIG. 7B) are updated.

As a result of the processing in step S402, the updated DNN model can perform training regarding the 2-class classification as to whether the difficult-to-classify case or not and training regarding class classification of the difficult-to-classify case, while the classification accuracy with regard to training data for which the classification accuracy was originally high is maintained.

Modifications

In step S202, the searching unit 1100 may present to the user the training data set to which the same “difficult-to-classify” label is provided. The method in which the training data set is presented to the user is not limited to a specific presentation method. For example, training data may be displayed on a display device in sets of training data having the same “difficult-to-classify” label, or a projection device may be caused to perform projection of training data in sets of training data having the same “difficult-to-classify” label. Also, other information may be presented to the user in addition to or in place of training data presented in sets of training data having the same “difficult-to-classify” label. For example, the CNN feature vector similarity, estimation results in the initial DNN model 120, etc., may be presented. By performing presentation to the user in such a manner, the user can set or correct the hyperparameters Ts and Tc, for example.

In such a manner, according to the present embodiment, training in a neural network that performs a classification task can be performed efficiently so that the classification accuracy with regard to a specific class for which the classification accuracy is low is improved while the overall classification accuracy is maintained.

### Second Embodiment

In the following embodiments including the present embodiment, the differences from the first embodiment will be described, and unless particularly mentioned in the following, the embodiments are regarded as being similar to the first embodiment. In the first embodiment, training of a classification task was performed. In the present embodiment, training is performed of an object region detection task, which is a task in which, if a specific object is included in an input image, the image region of the specific object in the input image is detected (estimated).

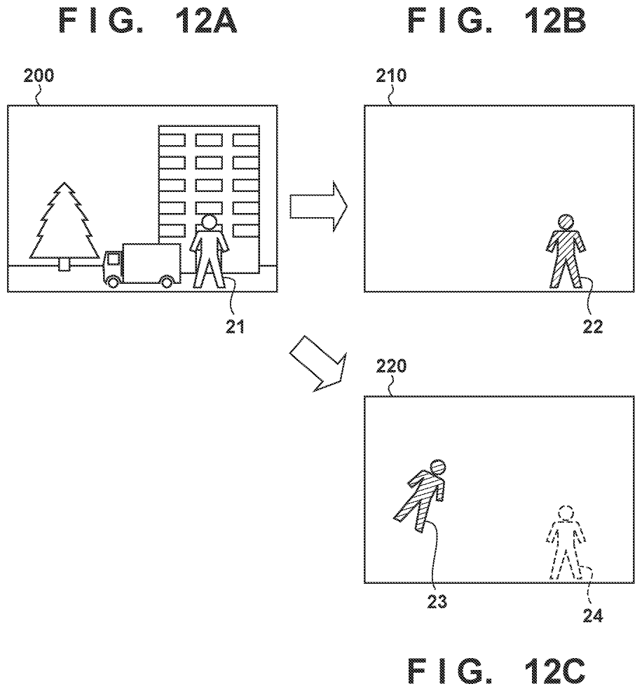

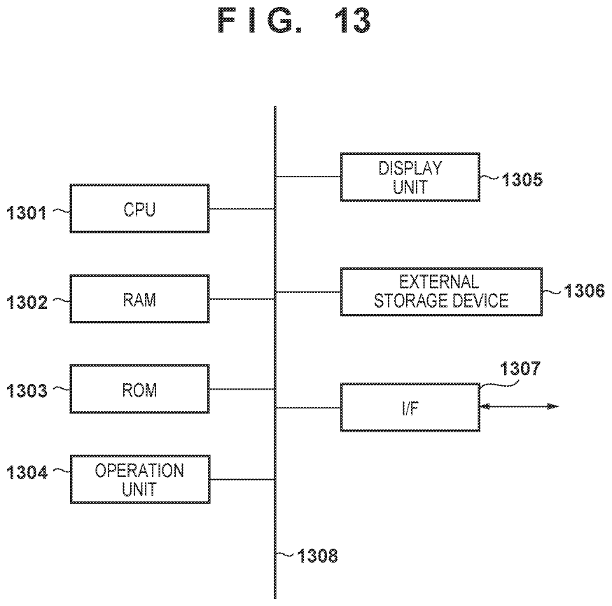

For example, suppose that image 200 (an image including a human-body region 21) in FIG. 12A is input to a DNN that has already trained an object region detection task in which the human body is used as the specific object. If the DNN is successful in performing estimation correctly, a region 22 in which a human body is present is output, as illustrated in image 210 in FIG. 12B. However, if the DNN fails to perform the estimation, a case in which a region 23 in which a human body is not present is erroneously output (mis-detection) and a case in which a region 24 in which a human body is present cannot be detected (non-detection) occur, as illustrated in image 220 shown in FIG. 12C. In the present embodiment, the accuracy of an object region detection task is improved by suppressing the occurrence of a non-detected case that is consistently difficult to detect and a case that is readily mis-detected consistently.

First, with regard to one example of a flow of training processing of a DNN for performing an object region detection task, points of difference from the flow of the training processing of the DNN performing a classification task will be described with reference to FIG. 5. Here, one type of object is detected using a DNN.

When subjecting a DNN performing an object region detection task to training, pairs of a training image and a teacher map are used as training data. A training image is an image including the object the training of which by the DNN is desired, and a teacher map is a binary image in which the pixel value corresponding to pixels forming the region of the object in the training image is 1, and the pixel value corresponding to pixels forming regions other than the region is 0.

First, as illustrated as (1), a training image is input to an input layer of the DNN, and by causing intermediate and output layers to operate, an estimation map indicating an estimated region of the object in the training image is output from the output layer. An estimation map is a two-dimensional map indicating an estimated region in which the object is estimated as being present in a training image, and the pixel values of the pixels in the two-dimensional map have a value of 0 to 1, inclusive. The closer the pixel value of a pixel is closer to 1, the higher the estimated probability of the pixel being a pixel forming a region in which the object is present. Note that, in a case in which multiple objects are to be detected, a number of estimation maps corresponding to the number of objects are output.

Next, as illustrated as (2), a function value obtained by inputting the difference between the estimation map and the teacher map to a loss function is calculated as a loss. The calculation of loss is performed by using a preset loss function and based on the difference between pixel values of the pixels at the same position in the estimation map and the teacher map.

Finally, as illustrated as (3), the weighting coefficients of layers in the DNN are updated based on the calculated loss using back propagation, etc. Since back propagation is a known technique, description thereof is omitted.

Furthermore, the training processing of the DNN is accomplished by updating the weighting coefficients of layers in the DNN by repeating the processing in (1), (2), and (3) above and thereby gradually reducing the loss (by making the estimation map closer to the teacher map).

In the present embodiment, the training data group 110 is a data set including a plurality of pairs of a training image and a teacher map, and is a data set for an object region detection task. The initial DNN model 120 is a DNN model that has performed training using such a training data group 110.

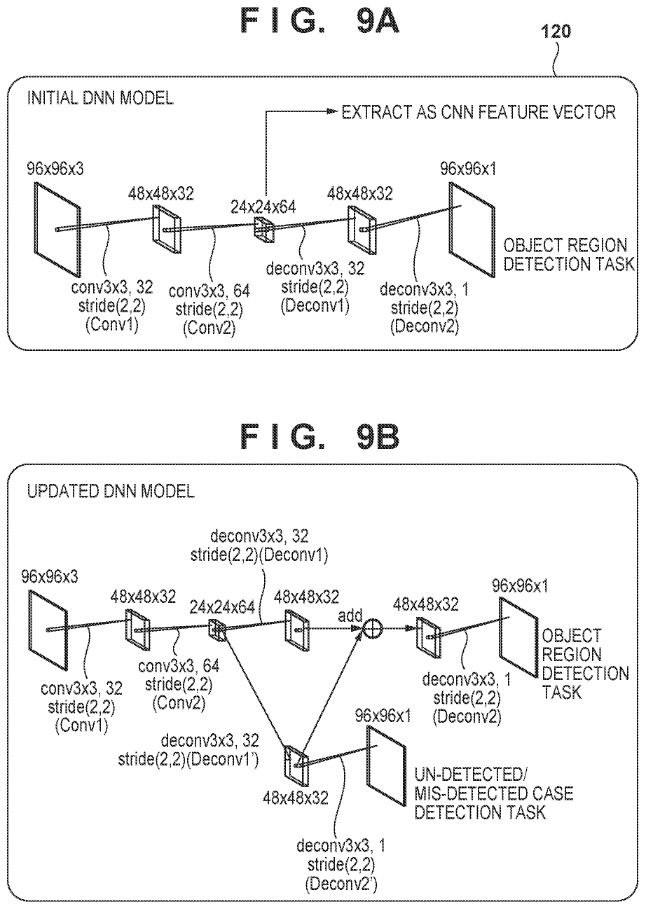

One example of an initial DNN model 120 performing an object region detection task is illustrated in FIG. 9A. The initial DNN model 120 illustrated in FIG. 9A is a neural network model that receives a 96×96 pixel RGB image (having three planes, namely the R plane, the G plane, and the B plane) as input, and outputs a single-channel, 96×96 pixel estimation map through two convolutional layers (Conv1, Conv2) and two deconvolutional layers (Deconv1, Deconv2). Note that the DNN structure applicable to the present embodiment is not limited to such a structure, and other structures may also be adopted.

The searching unit 1100 searches for training data for which the estimation result was non-detection or mis-detection upon object region detection performed by the initial DNN model 120. In particular, the searching unit 1100 searches for training data corresponding to estimation results close to one another on a CNN feature space, among non-detection/mis-detection estimation results.

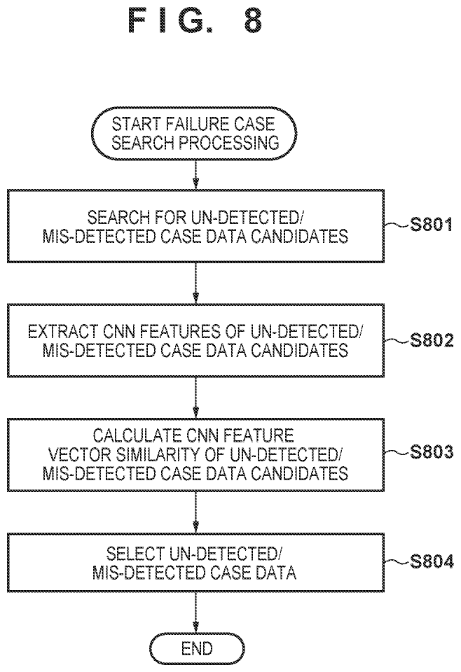

Similarly to the first embodiment, the neural network processing device 1000 pertaining to the present embodiment also performs processing based on the flowchart in FIG. 2, but performs processing based on the flowchart in FIG. 8 in step S202.

In step S801, the searching unit 1100 extracts, from the training data group 110, training data in which the object was non-detected or mis-detected by the initial DNN model 120. The searching unit 1100 extracts, from the training data group 110, training data in which the object was non-detected or mis-detected by the initial DNN model 120 by performing the following processing for each piece of training data in the training data group 110.

First, the searching unit 1100 inputs the training image included in the training data to the input layer of the initial DNN model 120, and by causing the intermediate and output layers to operate, outputs an estimation map corresponding to the training image from the output layer. Furthermore, the searching unit 1100 specifies a region in the estimation map corresponding to a region in the teacher map included in the training data that is formed from pixels having a pixel value of 1. Furthermore, if the specified region is a “region formed by pixels having pixel values (likelihoods) less than a threshold”, the searching unit 1100 sets a region in the training image that corresponds to the specified region as a “non-detected case data candidate”. Also, the searching unit 1100 specifies a region in the estimation map corresponding to a region in the teacher map included in the training data that is formed from pixels having a pixel value of 0. Furthermore, if the specified region is a “region formed by pixels having pixel values (likelihoods) greater than equal to the threshold”, the searching unit 1100 sets a region in the training image that corresponds to the specified region as a “mis-detected case data candidate”. Furthermore, the searching unit 1100 extracts, from the training data group 110, training data including a training image that includes a region set as a “non-detected case data candidate” or a “mis-detected case data candidate”.

In step S802, for each piece of training data extracted from the training data group 110 in step S801, the searching unit 1100 acquires the output (CNN feature vector) from an intermediate layer of the initial DNN model 120 when the training image included in the training data was input. The CNN feature vector may be extracted from the entire image region of the training image, or may be extracted from a local region including the region having been set as a “non-detected case data candidate” or a “mis-detected case data candidate” in the training image. Also, the CNN feature vector may be extracted from any layer that is present as an intermediate layer.

In step S803, the searching unit 1100 calculates the similarity (CNN feature vector similarity) between CNN feature vectors acquired in step S802, similarly to above-described step S303.

In step S804, the searching unit 1100 selects “non-detected case data” from the “non-detected case data candidates” or selects “mis-detected case data” from the “mis-detected case data candidates” based on the CNN feature vector similarity calculated in step S803.

The searching unit 1100 specifies, from among a set of training images including “non-detected case data candidates”, training images for which the CNN feature vector similarity is greater than or equal to the threshold Ts, and selects the “non-detected case data candidates” in the specified training images as “non-detected case data”. Also, the searching unit 1100 specifies, from among a set of training images including “mis-detected case data candidates”, training images for which the CNN feature vector similarity is greater than or equal to the threshold Ts, and selects the “mis-detected case data candidates” in the specified training images as “mis-detected case data”.

Furthermore, the searching unit 1100, for selected “non-detected case data” or “mis-detected case data”, newly creates a region-of-difficulty teacher map as additional teacher information. A region-of-difficulty teacher map is an image in which the pixel value of the undetected or mis-detected region is 1 and the pixel value of other regions is 0. Furthermore, the searching unit 1100 provides a “difficult-to-detect” label to the selected “non-detected case data” or “mis-detected case data”. The “difficult-to-detect” label is teacher information to which an ID for determining similar case data is assigned, and for example, the ID that is assigned is different between a given set of similar non-detected case data and a given set of similar mis-detected case data.

As a result of the above-described processing, a “difficult-to-detect” label is added by the searching unit 1100 to a set of training data in the training data group 110 which were successfully distinguished in the CNN feature space but in which the object is difficult to detect.

Returning to FIG. 2, in step S203, the updating unit 1200 adds a network structure for detecting the non-detected and mis-detected cases to an intermediate layer of the initial DNN model 120. Specifically, the updating unit 1200 adds, to the initial DNN model 120, one or more layers that receive CNN feature vectors as input and detect the non-detected and mis-detected cases, and updates the initial DNN model 120 into a structure in which the output from the added layers is added to the output of a layer after a layer that extracted the CNN feature vectors. The layers added here are added so as to branch from the same layer as the intermediate layer that extracted the CNN feature vectors in step S202. Note that the number of the added layers that branch is the same as the number of IDs of the “difficult-to-detect” labels provided by the searching unit 1100.

FIG. 9B illustrates one example of a structure of the initial DNN model 120 after updating (updated DNN model), which is obtained by updating the initial DNN model 120 having the structure illustrated in FIG. 9A using the updating unit 1200. The structure illustrated here is a structure when there is one pattern of a difficult-to-detect region, that is, a structure when there is one type of “difficult-to-detect” label. For convenience, the two convolutional layers in the initial DNN model 120 are referred to as a Conv1 layer and a Conv2 layer, and the two deconvolutional layers in the initial DNN model 120 are referred to as a Deconv1 layer and a Deconv2 layer. The Conv1 layer receives a 96×96 pixel RGB image (having three planes, namely the R plane, the G plane, and the B plane) as input, and outputs a 48×48×32ch three-dimensional tensor. The Conv2 layer receives the output from the Conv1 layer as input, and outputs a 24×24×64ch three-dimensional tensor. The Deconv1 layer receives the output from the Conv2 layer as input, and outputs a 48×48×32ch three-dimensional tensor, and the Deconv2 layer receives the output from the Deconv1 layer as input, and outputs a 96×96×1ch estimation/detection map. When the 24×24×64ch three-dimensional tensor output from the Conv2 layer is used as the CNN feature vectors used in the difficult case searching processing in step S202, a Deconv1′ layer and a Deconv2′ layer are added to the network structure of the initial DNN model 120 as a result of the network structure update processing in step S203. The Deconv1′ layer receives the 24×24×64ch three-dimensional tensor that is the output from the Conv2 layer as input, and outputs a 48×48×32ch three-dimensional tensor. The Deconv2′ layer receives the output of the Deconv1′ layer as input, and outputs an “estimation map in which a non-detected case is detected” or an “estimation map in which a mis-detected case is detected”. Furthermore, in step S203, a structure for adding the three-dimensional tensor that is the output from the Deconv1 layer and the three-dimensional tensor that is the output from the Deconv1′ layer is added to the network structure of the initial DNN model 120. Note that the configuration of the one or more layers that are added is not limited to this, and any structure can be added.

In step S204, the updating unit 1200 outputs the updated DNN model having the structure updated in step S203. Then, in step S205, the training processing unit 1300 subjects the updated DNN model output from the updating unit 1200 in step S204 to network training processing for performing the object region detection task. Similarly to the first embodiment, in order to improve the accuracy with regard to difficult-to-detect cases while maintaining the accuracy with regard to existing training data for which the object region detection accuracy is already high, layers (the Deconv1′ layer and the Deconv2 layer in the example in FIG. 9B) including and after the added layers are subjected to training in the training process. The training here is performed using the training data extracted by the searching unit 1100, and the region-of-difficulty teacher maps provided by the searching unit 1100 are used as teacher maps in the training.

In such a manner, according to the present embodiment, training in a neural network that performs an object region detection task can be performed efficiently so that the object region detection accuracy with regard to a specific case that is readily undetected or mis-detected is improved while the overall detection accuracy is maintained.

### Third Embodiment

The present embodiment provides a neural network processing device that carries out efficient training when new training data is added to a DNN model that has already performed training. Note that, while a DNN model that performs an object region detection task will be described as one example in the present embodiment, application to other tasks such as a classification task is also possible.

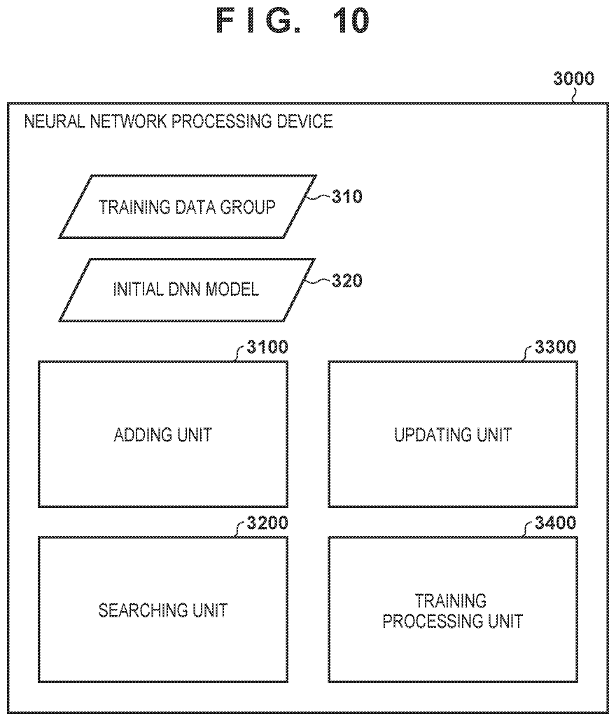

An example of a functional configuration of a neural network processing device 3000 pertaining to the present embodiment will be described with reference to the block diagram in FIG. 10. A training data group 310, an initial DNN model 320, an updating unit 3300, and a training processing unit 3400 are respectively similar to the training data group 110, the initial DNN model 120, the updating unit 1200, and the training processing unit 1300 in the second embodiment.

The initial DNN model 320 is a DNN model that has performed training using the training data group 310, and has acquired weighting coefficients that have undergone training so as to output an estimation map in response to an unknown input image. However, the initial DNN model 320 may already have added thereto a configuration for outputting an estimation map for difficult-to-detect case data based on the existing training data group 310. In this case, a “difficult-to-detect case” label is provided to the existing training data group 310 as additional teacher information.

An adding unit 3100 adds new training data to the training data group 310. A searching unit 3200 searches for training data for which the estimation result was non-detection or mis-detection upon object region detection performed by the initial DNN model 120 on the newly added training data.

Note that, in the present embodiment, the neural network processing device 3000 having the configuration in FIG. 10 is formed using one device. However, the neural network processing device 3000 having the configuration in FIG. 10 may be formed using multiple devices.

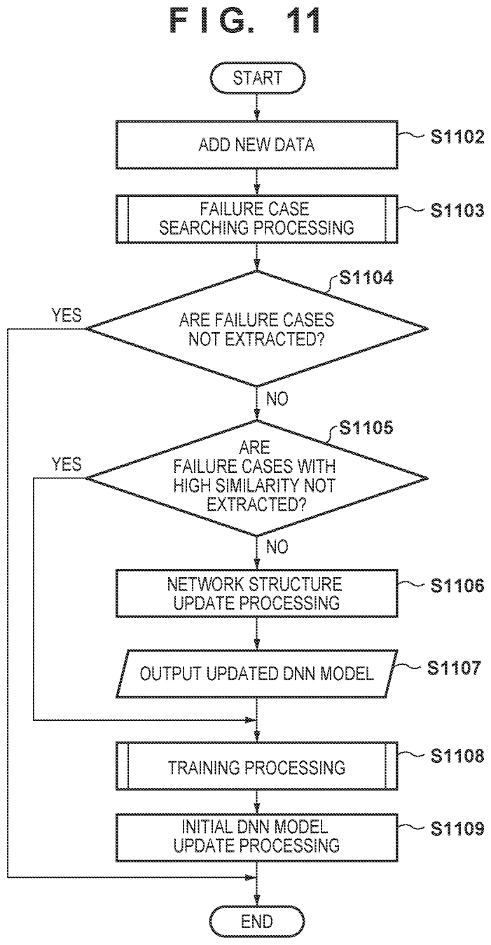

Processing performed by the neural network processing device 3000 pertaining to the present embodiment will be described based on the flowchart in FIG. 11.

In step S1102, the adding unit 3100 adds a set of newly added training data to the existing training data group 310. It is desirable that the number of newly added training data be a certain number or more. For example, in a case in which a configuration is adopted such that training data is uploaded as needed to a cloud database, the present processing is executed once the number of pieces of added training data exceeds a threshold set by the user.

In step S1103, the searching unit 3200 searches for training data including a training image that includes non-detected case data and training data including a training image that includes mis-detected case data among the newly added training data by performing the processing in above-described steps S801 to S804. The result of the search among the newly added training data would correspond to one of the cases (a) to (d) below.

(a) Detection was successfully performed for all added training data (there is no training data including a training image that includes non-detected case data or training data including a training image that includes mis-detected case data).

(b) Anew difficult-to-detect case set is extracted (there is either training data including a training image that includes non-detected case data or training data including a training image that includes mis-detected case data).

(c) (In a case in which there already is training data provided with a “difficult-to-detect case” label) There is training data for which the CNN feature vector similarity between the training data and the existing difficult-to-detect case set is greater than or equal to the threshold.

(d) While there is training data including a training image that includes non-detected case data or training data including a training image that includes mis-detected case data, there is no added training data for which the CNN feature vector similarity on the CNN feature space is greater than or equal to the threshold.

In step S1104, the searching unit 3200 determines whether or not there was a training image including non-detected case data or mis-detected case data. If the result of this determination is that there was a training image including non-detected case data or mis-detected case data, processing proceeds to step S1105.

On the other hand, if there was no training image including non-detected case data or mis-detected case data (i.e., case (a) in step S1104), the processing based on the flowchart in FIG. 11 is terminated. However, processing may be advanced to step S1108 and training processing using the added training data may be carried out in a case in which there was no training image including non-detected case data or mis-detected case data.

In step S1105, the searching unit 3200 determines whether or not a difficult-to-detect case set has been newly extracted. If the result of this determination is that a difficult-to-detect case set has been newly extracted, that is, in case (b) in step S1104, processing proceeds to step S1106. On the other hand, if there is no new difficult-to-detect case, that is, in case (c) or (d) in step S1104, processing proceeds to step S1108.

Step S1106 and step S1107 are respectively similar to step S203 and step S204 in the second embodiment, and thus description thereof is omitted. If a new difficult-to-detect case is extracted in step S1103, an updated DNN model in which a sub-network for detecting the difficult-to-detect case is added is generated by the present processing.

In step S1108, the training processing unit 3400 subjects the updated DNN model output from the updating unit 3300 in step S1107 to network training processing for performing the object region detection task. Here, the layer(s) subjected to training are determined in accordance with the result of the difficult case searching processing performed on the added training data. That is, if the result of the search in step S1103 is (d), layers including those before the layer that extracted the CNN feature vectors are subjected to training because the performance of the intermediate layer extracting CNN feature vectors is not sufficient. If the result is (b) or (c), layers including and after the sub-network for detecting the extracted difficult-to-detect case are subjected to training. If training is to be performed in a case in which the result is (a), any layer in the updated DNN model may be subjected to training.

As a result of the above-described processing, in the present embodiment, overall performance is improved by suppressing the occurrence of non-detected and mis-detected cases while reducing the influence of degradation on the current detection accuracy in a case in which unknown training data is newly added.

### Fourth Embodiment

In the neural network processing device 1000 in FIG. 1, the functional units other than the training data group 110 may be implemented using hardware, but also may be implemented using software (computer programs). Similarly, in the neural network processing device 3000 in FIG. 10, the functional units other than the training data group 310 may be implemented using hardware, but also may be implemented using software (computer programs). A computer serving as an information processing device capable of executing such software is applicable to the neural network processing device 1000 in FIG. 1 and the neural network processing device 3000 in FIG. 10.

An example of a hardware configuration of a computer device applicable to the neural network processing device 1000 in FIG. 1 and the neural network processing device 3000 in FIG. 10 will be described with reference to the block diagram in FIG. 13.

A CPU 1301 executes various types of processing using computer programs and data stored in a RAM 1302 and a ROM 1303. Accordingly, the CPU 1301 controls operation of the entire computer device, and also executes or controls each type of processing described above as being carried out by the neural network processing device 1000 in FIG. 1 and the neural network processing device 3000 in FIG. 10.

The RAM 1302 has an area for storing computer programs and data loaded from the ROM 1303 and an external storage device 1306, and data received from the outside via an interface (I/F) 1307. Furthermore, the RAM 1302 includes a work area that is used by the CPU 1301 when executing various types of processing. In such a manner, the RAM 1302 can provide various areas as appropriate. The ROM 1303 has stored therein configuration data and a startup program of the computer device, etc.

An operation unit 1304 is a user interface such as a keyboard, a mouse, or a touch panel screen, and the user can input various types of instructions and information (such as the above-described thresholds) to the CPU 1301 by operating the operation unit 1304.

A display unit 1305 includes a liquid-crystal screen, a touch panel screen, etc., and can display results of the processing by the CPU 1301 using images, characters, etc. Note that the display unit 1305 may also be a projection device such as a projector that performs projection of images, characters, etc.

The external storage device 1306 is a large-capacity information storage device such as a hard disk drive device. An operating system (OS) is saved in the external storage device 1306. In addition, computer programs and data for causing the CPU 1301 to execute or control each type of processing described above as being carried out by the neural network processing device 1000 and the neural network processing device 3000 are saved in the external storage device 1306. The computer programs saved in the external storage device 1306 include computer programs allowing the CPU 1301 to realize the functions of the functional units other than the training data group 110 in the neural network processing device 1000 in FIG. 1. In addition, the computer programs saved in the external storage device 1306 include computer programs allowing the CPU 1301 to realize the functions of the functional units other than the training data group 310 in the neural network processing device 3000 in FIG. 10. Also, the data saved in the external storage device 1306 includes the above-described training data group 110 and the training data group 310, information treated in the above description as known information, etc.

The computer programs and data saved in the external storage device 1306 are loaded onto the RAM 1302 as appropriate in accordance with control by the CPU 1301 to be processed by the CPU 1301.

The I/F 1307 is a communication interface that the computer device uses to perform data communication with external devices. For example, training data may be downloaded onto the computer device from an external device via the I/F 1307, or the results of processing performed by the computer device may be transmitted to an external device via the I/F 1307.

The CPU 1301, the RAM 1302, the ROM 1303, the operation unit 1304, the display unit 1305, the external storage device 1306, and the I/F 1307 are all connected to a bus 1308. Note that the configuration of the computer device applicable the neural network processing device 1000 in FIG. 1 and the neural network processing device 3000 in FIG. 10 is not limited to the configuration illustrated in FIG. 13, and may be changed or modified as appropriate.

Note that the specific numerical values used in the above description are used to provide specific description, and are not used with the intension of limiting the above-described embodiments and modifications to these numerical values. Also, a part or an entirety of the embodiments and modifications described above may be combined with one another, as appropriate. In addition, a part or an entirety of the embodiments and modifications described above may be selectively used.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-174542, filed Sep. 25, 2019, which is hereby incorporated by reference herein in its entirety.

What is claimed is:

1. An information processing device comprising:
a setting unit configured to set, as difficult case data, training data for which an erroneous result is output by a hierarchical neural network that has performed training using a training data group;
an updating unit configured to generate an updated hierarchical neural network in which a layer for detecting the difficult case data is added to the hierarchical neural network; and
a training unit configured to perform training processing of the updated hierarchical neural network using the training data group.

2. The information processing device according to claim 1, wherein
the setting unit acquires, for training data for which an erroneous result is output by the hierarchical neural network, a feature vector that can be obtained from an intermediate layer of the hierarchical neural network, and performs the setting based on a similarity between the acquired feature vectors.

3. The information processing device according to claim 2, wherein
the setting unit sets, as the difficult case data, training data for which the similarity is greater than or equal to a threshold among training data for which an erroneous result is output by the hierarchical neural network.

4. The information processing device according to claim 1, wherein
the setting unit acquires, for training data for which a correct answer is output by the hierarchical neural network, a feature vector that can be obtained from an intermediate layer of the hierarchical neural network, and sets training data, among the training data, for which a similarity between the feature vector and a feature vector of the difficult case data is greater than or equal to a threshold as the difficult case data.

5. The information processing device according to claim 1, wherein
in the training processing, the training unit updates weighting coefficients in the layer and a layer after the layer based on a loss in the layer.

6. The information processing device according to claim 1, wherein
the setting unit presents the difficult case data to a user.

7. The information processing device according to claim 1 further comprising
an adding unit configured to add new training images to the training data group, wherein
the setting unit sets, as the difficult case data, training data, among the new training images, for which an erroneous result is output by the hierarchical neural network.

8. The information processing device according to claim 1, wherein
the erroneous result is misclassification of an object.

9. The information processing device according to claim 1, wherein
the erroneous result is non-detection or mis-detection of an object.

10. An information processing method comprising:
setting, as difficult case data, training data for which an erroneous result is output by a hierarchical neural network that has performed training using a training data group;
generating an updated hierarchical neural network in which a layer for detecting the difficult case data is added to the hierarchical neural network; and
performing training processing of the updated hierarchical neural network using the training data group.

11. A non-transitory computer-readable storage medium storing a computer program for causing a computer to function as:
a setting unit configured to set, as difficult case data, training data for which an erroneous result is output by a hierarchical neural network that has performed training using a training data group;
an updating unit configured to generate an updated hierarchical neural network in which a layer for detecting the difficult case data is added to the hierarchical neural network; and
a training unit configured to perform training processing of the updated hierarchical neural network using the training data group.
